(19) United States
(12) Patent Application Publication
(10) Pub. No.: US 2026/0018588 A1
(43) Pub. Date: Jan. 15, 2026

(54) ACTIVATION OF METAL HYDROGEN BATTERIES

(71) Applicant: EnerVenue Holdings, Ltd., Fremont, CA (US)

(72) Inventors: Govind Mittal, Fremont, CA (US); Wenxiao Huang, Fremont, CA (US); Jingyi Zhu, San Jose, CA (US); Jacob Lamkin, Fremont, CA (US); Jacob Marshall, Fremont, CA (US); Mark Aiello, Fremont, CA (US); Andrzej Skoskiewicz, Fremont, CA (US)

(21) Appl. No.: 19/264,474

(22) Filed: Jul. 9, 2025

Related U.S. Application Data
(60) Provisional application No. 63/671,559, filed on Jul. 15, 2024.

(51) Int. Cl. H01M 4/04; H01M 12/08; H02J 13/00

(52) U.S. Cl. CPC H01M 4/0447; H01M 12/08; H02J 13/00002

(57) ABSTRACT

According to some embodiments, a method of activating a battery system is presented. The method includes initiating a first activation sequence in a first time period on a first energy rack system, the first activation sequence including alternating charge and discharge cycles; initiating a second activation sequence in a second time period following the first time period on a second energy rack system, the second activation sequence including alternating charge and discharge cycles; and executing the first activation sequence and the second activation sequence until activation completion, wherein the first activation sequence is coordinate with the second activation sequence such that charge cycles in the first activation sequence correspond with discharge cycles of the second activation sequence and discharge cycles in the first activation sequence correspond with charge cycles of the second activation sequence.

### RELATED APPLICATIONS

This application claims priority to U.S. Provisional Patent Application No. 63/671,559 filed Jul. 15, 2024, which is incorporated by reference herein in its entirety Technical Field

This disclosure is generally related to metal-hydrogen batteries, and more particularly to activation of metal hydrogen batteries used for grid-scale energy storage.

### DISCUSSION OF RELATED ART

For renewable energy resources such as wind and solar to be competitive with traditional fossil fuels, large-scale energy storage systems are needed to mitigate their intrinsic intermittency. To build large-scale energy storage, the cost and long-term lifetime are the utmost considerations. Currently, pumped-hydroelectric storage dominates the grid energy storage market because it is an inexpensive way to store large quantities of energy over a long period of time (about 50 years), but it is constrained by the lack of suitable sites and the environmental footprint. Other technologies such as compressed air and flywheel energy storage show some different advantages, but their relatively low efficiency and high cost should be significantly improved for grid-scale storage. Rechargeable batteries offer great opportunities to target low-cost, high-capacity and highly reliable systems for large-scale energy storage. Improving the reliability and deploy ability of rechargeable batteries and reducing cost of those batteries has become an important issue to realize large-scale energy storage.

The cost of the batteries includes the cost of assembly and the cost of conditioning (i.e. activation) of the battery after assembly. The activation cost includes the cost of power, the cost of the equipment to perform the activation, and the time required for the performance of the activation procedure. These activation costs can be considerable and the time in production is also considerable. Consequently, there is a need for better activation procedures in the field (rather than in production) and deployment of storage batteries.

### SUMMARY

According to some embodiments a method of activating a battery system is presented. The method includes initiating a first activation sequence in a first time period on a first energy rack system, the first activation sequence including alternating charge and discharge cycles; initiating a second activation sequence in a second time period following the first time period on a second energy rack system, the second activation sequence including alternating charge and discharge cycles; and executing the first activation sequence and the second activation sequence until activation completion, wherein the first activation sequence is coordinate with the second activation sequence such that charge cycles in the first activation sequence correspond with discharge cycles of the second activation sequence and discharge cycles in the first activation sequence correspond with charge cycles of the second activation sequence.

In some embodiments, each of the first energy rack system and the second energy rack system includes one or more coupled energy racks, each energy rack including a plurality of coupled batteries. In some embodiments, the plurality of batteries in each energy rack are coupled in series. In some embodiments, the plurality of coupled batteries in each energy rack are packaged in battery packs, each battery pack including a pair of batteries and a monitor coupled to the pair of batteries. In some embodiments, the method further includes recording activation data in each monitor of each battery pack. In some embodiments, the method further includes classifying each of the batteries according to the activation data.

In some embodiments, the method further includes detecting a fault during execution of the first activation sequence and the second activation sequence; suspending the first activation sequence and the second activation sequence; recovering from the fault; and resuming the first activation sequence and the second activation sequence. In some embodiments, suspending the first activation sequence and the second activation sequence includes stopping the charge or discharge cycle of the first activation sequence and the corresponding discharge or charge cycle of the second activation sequence in a time period and resuming the charge or discharge cycle of the first activation sequence and the corresponding charge or discharge cycle of the second activation sequence to complete the time period.

A battery system is also presented. In accordance with some embodiments, the battery system includes a first energy rack system; a first inverter coupled to the first energy rack system, the first inverter configured to couple power between the first energy rack system and a power grid; a second energy rack system; a second inverter coupled to the second energy rack system, the second inverter configured to couple power between the second energy rack system and the power grid; a power grid meter coupled to monitor power in the power grid; and a control system coupled to the first energy rack system, the second energy rack system, the first inverter, the second inverter, and the power grid meter, the control system including a processor that executes instructions to activate the first energy rack system and the second energy rack system, the instructions include instructions to initiate a first activation sequence in a first time period on a first energy rack system, the first activation sequence including alternating charge and discharge cycles; initiate a second activation sequence in a second time period following the first time period on a second energy rack system, the second activation sequence including alternating charge and discharge cycles; and execute the first activation sequence and the second activation sequence until activation completion, wherein the first activation sequence is coordinate with the second activation sequence such that charge cycles in the first activation sequence correspond with discharge cycles of the second activation sequence and discharge cycles in the first activation sequence correspond with charge cycles of the second activation sequence.

In some embodiments, each of the first energy rack system and the second energy rack system includes one or more coupled energy racks, each energy rack including a plurality of coupled batteries. In some embodiments, the plurality of batteries in each energy rack are coupled in series. In some embodiments, the plurality of coupled batteries in each energy rack are packaged in battery packs, each battery pack including a pair of batteries and a monitor coupled to the pair of batteries. In some embodiments, the instructions further include instructions to record activation data in each monitor of each battery pack. In some embodiments, the instructions further include instructions to classify each of the batteries from the activation data

In some embodiments, the instructions further include instructions to detect a fault during execution of the first activation sequence and the second activation sequence; suspend the first activation sequence and the second activation sequence; recover from the fault; and resume the first activation sequence and the second activation sequence. In some embodiments, the instructions to suspend the first activation sequence and the second activation sequence includes instructions to stop the charge or discharge cycle of the first activation sequence and the corresponding discharge or charge cycle of the second activation sequence in a time period and instructions to resume the charge or discharge cycle of the first activation sequence and the corresponding charge or discharge cycle of the second activation sequence to complete the time period.

These and other embodiments are discussed below with respect to the following figures.

### BRIEF DESCRIPTION OF THE FIGURES

FIGS. 1A and 1B illustrate an energy rack according to some embodiments of the present disclosure.

FIGS. 2A and 2B illustrate an activation procedure that is performed during production of a battery system.

FIG. 3 illustrates a battery system according to some embodiments of the present disclosure.

FIG. 4 illustrates an activation procedure according to some embodiments of the present disclosure.

FIG. 5 illustrates failure recovery in the activation procedure as illustrated in FIG. 4.

FIG. 6 illustrates a block diagram of a control system as illustrated in FIG. 3 and that executes the activation procedure illustrated in FIGS. 4 and 5.

FIGS. 7A, 7B, and 7C illustrate an energy rack with data storage according to some embodiments of the present disclosure.

FIG. 8 illustrates a process that is executed by the control system as illustrated in FIG. 6 for activating batteries in the battery system as illustrated in FIG. 3 using the process as illustrated in FIGS. 4 and 5.

These figures along with other embodiments are further discussed below.

### DETAILED DESCRIPTION

In the following description, specific details are set forth describing some embodiments of the present invention. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure.

This description illustrates inventive aspects and embodiments should not be taken as limiting—the claims define the protected invention. Various changes may be made without departing from the spirit and scope of this description and the claims. In some instances, well-known structures and techniques have not been shown or described in detail in order not to obscure the invention.

Embodiments of the present disclosure provide for an activation procedure for batteries that can be performed as the battery is being deployed and at the site of deployment. The activation process according to some embodiments of the present invention can, for example, be performed on metal hydrogen batteries.

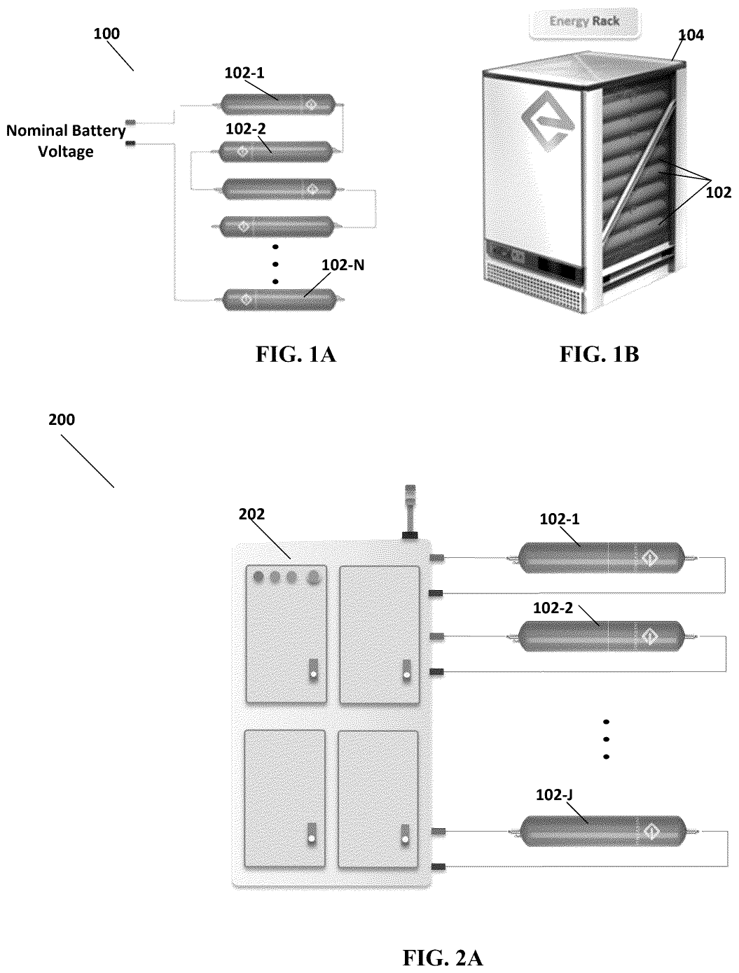

FIGS. 1A and 1B illustrate a battery arrangement 100 and a battery rack 104 according to some embodiments of the present disclosure. As shown in FIG. 1A, battery arrangement 100 includes N individual batteries 102 (batteries 102-1 through 102-N) that are electrically coupled. In the particular example illustrated in FIG. 1A, batteries 102-1 through 102-N are coupled in series. For example, if N=50 and each of batteries 102 has a 30V nominal voltage, then the series coupled battery arrangement 100 illustrated in FIG. 1A can have a 1500V nominal battery voltage.

Although FIG. 1A illustrates a battery arrangement 100 where N batteries 102 are coupled in series, batteries 102 can be electrically coupled in parallel as well. Further, battery arrangement 100 can be electrically coupled in a combination of parallel and serial connections according to some embodiments of the present disclosure.

In some embodiments of the present disclosure, batteries 102 can be metal hydrogen batteries. Metal hydrogen batteries have been described in more detail in U.S. patent application Ser. No. 17/830,193, entitled “Electrode Stack Assembly for a Metal Hydrogen Battery,” filed on Jun. 1, 2022, which is herein incorporated by reference. Another embodiment of electrode stack 101 is described in U.S. patent application Ser. No. 17/687,527, entitled “Electrode Stack Assembly for a Metal Hydrogen Battery,” filed on Mar. 4, 2022, which is also incorporated by reference in its entirety. Other examples of a metal-hydrogen battery have been disclosed in U.S. Prov. Application 63/658,165 entitled “Nickel-Hydrogen Battery Configurations for Grid-Scale Energy Storage,” filed on Jun. 10, 2024, which is also herein incorporated by reference in its entirety.

FIG. 1B illustrates an energy rack 104 that is used to contain battery arrangement 100. Energy rack 104 contains each of batteries 102-1 through 102-N and includes all electrical connections and may include monitoring electronics to operate energy rack 104. For example, in some embodiments energy rack 104 may include electronics for temperature control of batteries 102-1 through 102-N, state-of-charge monitoring, current and voltage monitoring, or other controls.

After construction of each of batteries 102, it is conventional to activate each of batteries 102 prior to assembly into energy rack 104 and shipment to a final destination. Activation of battery 102 involves a sequence of controlled charge/discharge cycles that are designed to condition the electrodes in battery 102 prior to full service. The charge and discharge cycles activate the materials in the assembled battery and essentially makes the battery 102 ready for normal use. Without activation, battery 102 is not considered ready for commercial use. Activating batteries 102 prior to assembly into the energy rack 104 requires multiple step of wiring, unwiring, operating activation equipment and other processes. To reduce the number of steps involved in activation, batteries 102 can be activated after they are being assembled within an energy rack 104. However, activation of batteries 102 that are then arranged in energy rack 104 is a considerable bottleneck in the production process as it may take tens of hours, or even days, of configured charge/discharge cycles to perform the operation. In addition, activation requires high voltage activation equipment which are expensive and requires more care and management.

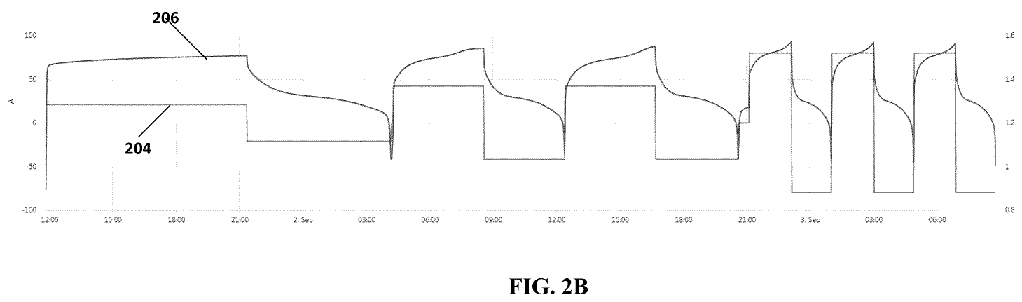

FIG. 2A illustrates an apparatus 200 for activating batteries 102 at a production facility. As shown in FIG. 2A, apparatus 200 includes a voltage cycler 202. Voltage cycler 202 can be coupled to J batteries 102 and can activate each of batteries 200-1 through 200-J using a cycling program as illustrated in FIG. 2B. Voltage cycler 202 provides a sequence of charge and discharge cycles across each of batteries 200-1 through 200-J. As shown in FIG. 2B, curve 204 shows constant current charge and discharge cycles while curve 206 shows the state of one of batteries 200-1 through 200J. As is illustrated, a sequence starts with low current charges and discharges over long times and progresses to shorter timed, high current charge and discharge cycles. As is illustrated in FIG. 2B, the sequence can take a long time, two and half days in the example shown in FIG. 2B, to complete. The actual period and intensity of individual charge and discharge cycles can be arranged to efficiently condition the materials in each of batteries 102 in preparation for future use of batteries 102.

Additionally, multiple characterization parameters for each of batteries 200-1 through 200-J can be compiled during the activation process. For example, individual vessel efficiencies (coulombic efficiency, energy efficiency, charge & discharge energy (in watt hour), charge and discharge energy (in amp hour), mean charge and discharge voltage for each of the cycles in the activation process for each of batteries 200-1 through 200-J can be recorded. These recorded parameters can then be used to classify the performance of each of batteries 200-1 through 200-J. In particular, a tiering process can be used to classify each of batteries 200-1 through 200-J according to tiers of performance. Batteries 200-1 through 200-J can then be binned so that energy packs 104 can be formed with similarly tiered batteries, which helps to balance charge and discharge functions in each energy pack 104.

As discussed above, the activation cycle takes a considerable amount of time, uses a lot of power, and takes a large floor footprint during production. Furthermore, activated batteries are subject to additional shipping restrictions, which also increases the costs of producing and supplying battery components. Consequently, these restrictions can be avoided by shipping non-activated batteries.

In accordance with embodiments of the present disclosure, batteries 102 are placed into energy rack 104 and shipped to their on-site destination without being activated. The activation process, as discussed further below, can be performed on-site. However, it should be considered that the activation process described here can be performed at any location, including at the production facility, and takes less overall energy and requires less overall time to perform.

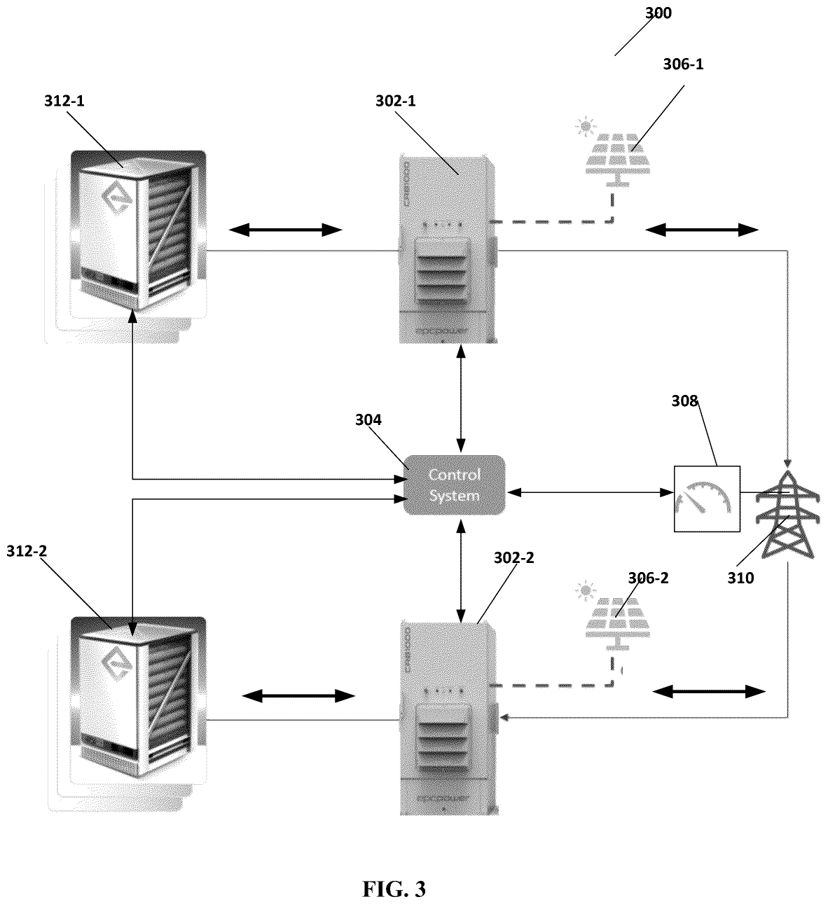

FIG. 3 illustrates an installed system 300 according to some embodiments. As shown in FIG. 3, a pair of energy rack systems 312-1 and 312-2 are installed. As illustrated in FIG. 3, energy rack system 312-1 is electrically coupled to inverter 302-1, which itself is coupled to grid power 310. Further, energy rack system 312-2 is electrically coupled to inverter 302-2, which is coupled to grid power 310. Inverters 302-1 and 302-2 provide electrical power to energy rack systems 312-1 and 312-2 for charging energy rack systems 312-1 and 312-2. Inverters 302-1 and 302-2 also receives electrical power from energy rack systems 312-1 and 312-2 during discharge and directs the electrical power to power grid 310. Consequently, inverters 302-1 through 302-2 controls the charging and discharging of energy rack systems 312-1 and 312-2 and provides or receives power from power grid 310 accordingly.

Further, inverters 302-1 and 302-2 can be configured to operate in a charge mode, a discharge mode, and an idle mode. In charge mode, inverters 302-1 and 302-2 provide power to the corresponding energy rack systems 312-1 and 312-2. The power can be received from grid 310 or from power sources 306-1 and 306-2. In discharge mode, inverters 302-1 and 302-2 receive power from the corresponding energy rack system 312-1 and 312-2 and provide power to grid 310. In idle mode, inverters 302-1 and 302-2 do not transfer power.

In some embodiments, each of energy rack systems 312-1 and 312-2 can include more than one individual energy rack 104 as is illustrated in FIGS. 1A and 1B. A set of multiple energy racks 104 can, for example, be coupled in parallel to form energy rack systems 312-1, although energy racks 104 can be coupled in any combination of series and parallel configurations. Another set of multiple energy racks 104 are coupled to form energy rack systems 312-2. Although in most embodiments, energy rack systems 312-1 and 312-2 have the same number of individual energy racks 104, each of energy rack systems 312-1 and 312-2 can have any number of individual energy racks 104.

As is further shown in FIG. 3, inverters 302-1 and 302-2 may be multiport inverters and receive power from other power sources 306-1 and 306-2, respectively. Power sources 306-1 and 306-2 may be any power generation system, including solar, wind, geothermal, or other source of power.

As is also shown in FIG. 3, a control system 304 is coupled to energy rack system 312-1 and 312-2, inverters 302-1 and 302-2, and power monitor 308. Power monitor 308 is coupled to power grid 310 to detect power transferred to grid 310 and power transferred from grid 310. Control system 304 can control inverters 302-1 and 302-2 and monitor the charge states of energy rack systems 312-1 and 312-2 and the power transfer into and out of power grid 310 through power monitor 308.

In particular, control system 304 controls the available battery energy storage inverters 302-1 and 302-2 to carry out an activation process. In accordance with embodiments of the present disclosure, the activation process will be performed in pairs. In particular, the activation process for energy rack system 312-1 is performed in concert with the activation process for energy rack system 312-2. Consequently, the two sets of multiple energy rack system 312-1 and 312-2, each set connected to a separate battery inverter 302-1 and 302-2, respectively, are activated in a coordinated activation procedure. In some embodiments, control system 304 can execute an activation process using the pair of multiple energy rack systems 312-1 and 312-2 such that the net flow of power imported from the grid is significantly reduced from that used if individual activation procedures are performed on energy rack systems 312-1 and 312-2 separately. In the activation process, when one of energy rack systems 312-1 or 312-2 is charging, the other of energy rack systems 312-1 or 312-2 can be discharging. In systems that include alternative power sources 306-1 and 306-2 providing additional power to inverters 302-1 and 302-2 can be used to further reduce reliance on grid power from power grid 310 during the activation process.

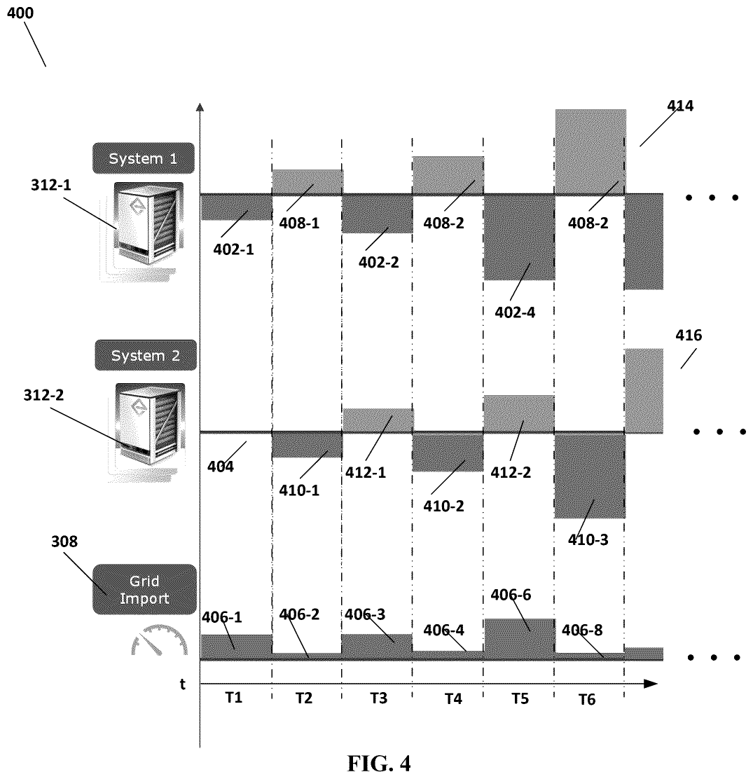

FIG. 4 illustrates an activation process 400 that can be performed on-site (or any other location with access to grid power 310). As shown in FIG. 3, energy rack systems 312-1 and 312-2 with energy racks 104 as illustrated in FIG. 1 are packaged and shipped with inactivated batteries 102. An inactivated battery is a battery that is fully manufactured and assembled but that has not gone through an activation or battery forming process, which as discussed with respect to FIGS. 2A and 2B involves multiple cycles of charging and discharging. In traditional activation, as discussed above, activation of each battery 102 uses specialized battery formation equipment, most referred to as battery cyclers 202 at the production site as illustrated in FIG. 2A. As is also discussed above, shipping energy rack systems 312-1 or 312-2 with energy racks 104 having inactivated batteries 102 can be beneficial as it reduces the number of regulations that affect the shipment of activated batteries 102, saves the manufacturing time of activation at the production facility, and saves the power required to perform the activation at the production facility. Of course, the time for activation and the power required for activation are then incurred on-site on installation.

FIG. 4 illustrates an activation process 400 according to some embodiments of the present disclosure that can be executed by controller system 304. As illustrated in FIG. 4, controller system 304 executes an activation sequence 414 on energy rack system 312-1 starting at time T1 and activates an activation sequence 416 on energy rack system 312-2 starting in time T2. Activation sequence 414 and activation sequence 416 are then aligned such that when energy rack system 312-1 is in a charging cycle, energy rack system 312-2 is either inactive in time T1 or in a discharge cycle. Conversely, when energy rack system 312-1 is in a discharge cycle, energy rack system 312-2 is in a charge cycle. Consequently, the discharge cycle executed in energy rack system 312-1 can provide power for the charge cycle executed in energy rack system 312-2 and the discharge cycle executed in energy rack system 312-2 can provide power for the charge cycle executed in energy rack system 312-1, thereby significantly reducing the overall power draw from power grid 310.

In embodiments where energy rack system 312-1 and 312-2 are structurally the same (i.e., having the same number of energy racks 104 each with the same number of batteries 102 coupled in the same way), then activation sequence 414 and activation sequence 416 can be the same. If energy rack systems 312-1 and 312-2 are not the same, the level of charge and discharge in each of activation sequence 414 and activation sequence 416 are configured to optimally condition each of energy rack system 312-1 and energy rack system 312-2 separately, but the periods of charge and discharge are coordinated such that when one of energy rack system 312-1 and energy rack system 312-2 is charging the other one of energy rack system 312-1 and energy rack system 312-2 is discharging.

In particular, FIG. 4 shows charge and discharge cycles for energy rack system 312-1 over time t executing activation sequence 414, charge and discharge cycles for energy rack system 312-2 over time t executing activation sequence 416, and the grid power 406 supplied during activation sequences 414 and 416 as measured by power monitor 308. In particular, the activation procedure 400 is illustrated over time periods T1 through T6, which illustrates a portion of activation process 400. As discussed above, activation process 400 is executed over some time and may include a large number of charge and discharge sequences for each of activation sequence 414 and activation sequence 416. In particular, each of activation sequences 414 and 416 can include N charge/discharge cycles, each of the N charge/discharge cycles having a duration T1 through TN, respectively, and each of the N charge/discharge cycles having charge/discharge rates of C/y. Further, although FIG. 4 illustrates an example where the duration T1 through TN of activation sequences 414 and 416 are aligned, in some embodiments the durations used in activation sequences 414 and 416 can differ.

In effect, activation procedure 400 performs activation sequence 414 energy rack system 312-1 and 312-2, with the start of activation sequence 414 on energy rack system 312-2 being delayed to start in time period T2. Activation process 400 is an example that does not include input from power sources 306-1 and 306-2, which may affect the supplied grid power from grid power 310.

As illustrated in FIG. 4, in time period T1 controller system 304 executes a charge cycle 402-1 to energy rack system 312-1 while in time period T1 control system 304 leaves energy rack system 312-2 at idle 404. As is further illustrated, power monitor 308 measures a power draw 406-1 from power grid 310, which provides the power for charging cycle 402-1. In time period T2, controller system 304 executes a discharge cycle 408-1 on energy rack system 312-1 and a charge cycle 410-1 on energy rack system 312-2. The resulting power draw 406-2 from power grid 310 is low as some of the power for charge cycle 410-1 is obtained from discharge cycle 408-1. In time period T3, charge cycle 402-2 is executed on energy rack system 312-1 and discharge cycle 412-1 is executed on energy rack system 312-2, resulting in an overall power draw 406-3 from power grid 310. In time period T4, discharge cycle 408-2 is executed on energy rack system 312-1 and charge cycle 410-2 is executed on energy rack system 312-2 resulting in power draw 406-4 from power grid 310. In time period T5, charge cycle 402-4 is executed on energy rack system 312-1 and discharge cycle 412-2 is executed on energy rack system 312-2 resulting in power draw 406-6 from power grid 310. In time period T6, discharge 408-2 is executed on energy rack system 312-1 and charge cycle 410-3 is executed on energy rack system 312-2 resulting in power draw 406-8 from power grid 310.

Activation sequence 414, therefore, includes alternating charge cycles 402 (402-1 through 402-N) and discharge cycles 408 (408-1 through 408-N) and continues in time until the sequence is completed and all of the batteries 102 in energy rack system 312-1 are activated. Similarly, activation sequence 416 includes alternating charging cycles 410 (410-1 through 410-N) and discharge cycles 412 (412-1 through 412-N) and continues in time until the sequence is completed and all of the batteries 102 in energy rack system 312-2 are activated. As is illustrated, the charging cycles 402 are coordinated with discharge cycles 412 and charge cycles 410 are coordinated with discharge cycles 408 so that the power draw 406 from power grid 310 can be lower. Consequently, each of activation sequence 414 and 416 can have the same number N of charge/discharge cycles and the durations T1 through TN are the same, although individual durations can differ (i.e., Ti may not equal Tj, where Ti and Tj are arbitrary ones of T1 through TN).

Control system 304 can be configured such that the activation sequences 414 and 416 are executed and smoothly in the charge/discharge sequences that result in activation of batteries 102 of energy rack systems 312-1 and 312-2. Control system 304, as shown in FIG. 3, is then configured to control and monitor energy rack systems 312-1 and 312-2, inverters 302-1 and 302-2, and grid power meter 308. Control system 304 also ensure that if any system were to fail during activation, then control system 304 will automatically clear faults and attempt to recover the system 300 and resume the process where it left off in order to complete the activation sequence that is being performed. In the event one pair of the system is down (due to inverter or battery faults), control system 304 may be configured to continue the activation process of the second pair using grid power.

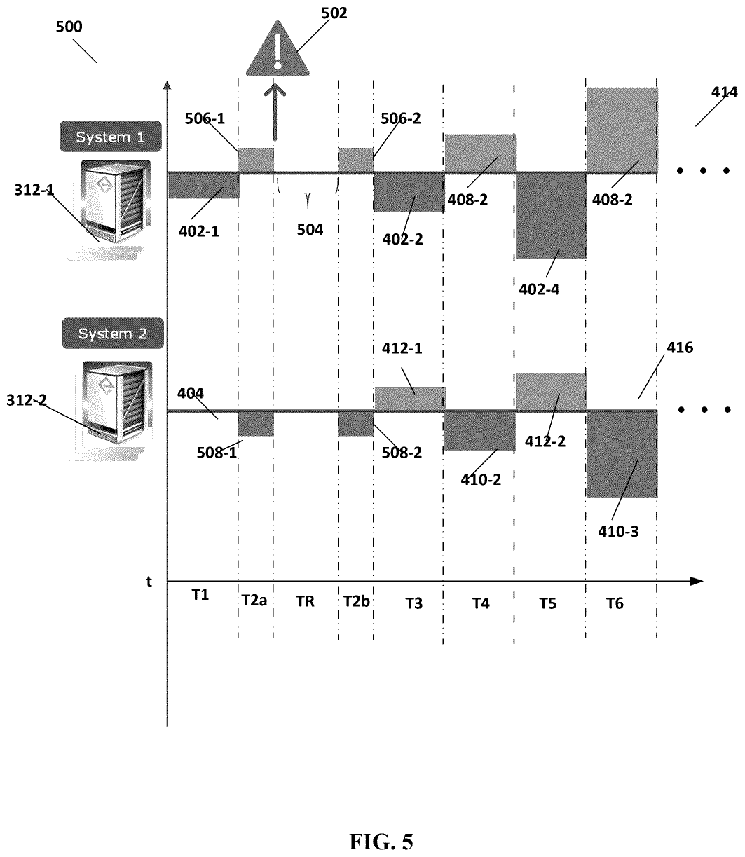

FIG. 5 illustrates an example of a recovery process 500 executed by control system 304 according to some embodiments of the present disclosure. In the example illustrated in the recovery process 500 illustrated in FIG. 5, a fault 502 is detected in period T2, during discharge cycle 408-1 of activation sequence 414 and the corresponding charge cycle 410-1 of activation sequence 416. Consequently, discharge cycle 408-1 and charge cycle 410-1 are disrupted and the charge/discharge cycles are suspended during recovery 504. During recovery 504, control system 504 determines the fault and takes steps to recover from the fault. In some cases, control system 504 may use any means, including technicians present on site, to repair the fault. Once the system has recovered at the end of recovery 504, the control system 504 resumes performing activation sequence 414 and 416.

Consequently, as illustrated in FIG. 5, during time period T2, discharge portion 506-1 and charge portion 508-1 have been performed during time period T2a. After recovery 504 during time period TR, discharge portion 506-2 and charge period 508-2 are performed during time period T2b and then sequences 414 and 416 transition to time period T3 and the activation sequences 414 and 416 continue to completion. Consequently, discharge cycle 408-1 is completed by the combination of discharge cycle 506-1 and 506-2 and charge cycle 410-1 is completed by the combination of charge cycles 508-1 and 508-2. Consequently, T2 is likely the combination of T2a and T2b. Therefore, in spite of fault 502, activation sequences 414 and 416 are completed. It should be noted that fault 502 can occur at any time (or at no time) during activation sequences 414 and 416. Additionally, there can be any number of faults 502 during activation sequences 414 and 416, each of which having the same recovery process 500 as illustrated in FIG. 5.

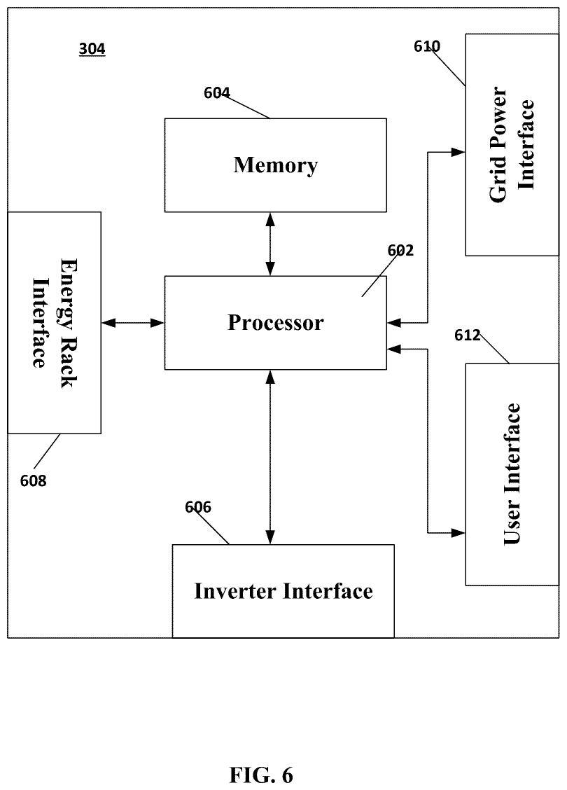

FIG. 6 illustrates a block diagram of control system 304. As shown in FIG. 6, control system 304 includes a processor 602 coupled to a memory 604. Processor 602 can be any device capable of executing instructions stored in memory 604. Processor 602 can include any processing device, including any microcomputer, microprocessor, ASIC, or other such device along with supporting circuitry capable of performing the functions described here. Memory 604 can be any combination of volatile and non-volatile memory capable of storing instructions and data as is described here. Processor 602, therefore, executes instructions stored in memory 604 to allow control system 304 to perform various tasks, including normal operation of system 300, activation of energy rack systems 312-1 and 312-2, maintenance functions for system 300, or other functions that may be executed by system 300.

As is further illustrated in FIG. 6, processor is coupled to a grid power meter interface, 610 which is configured to receive data from grid power meter 308. Processor 602 is further coupled to an inverter interface 606, which is configured to communicate with inverters 302-1 and 302-2 as illustrated in FIG. 3. Processor 602 can, for example, control the mode (charge mode, discharge mode, or idle mode) of each of inverters 302-1 and 302-2 to control the operation of energy rack systems 312-1 and 312-2, respectively.

Processor 602 is further coupled to energy rack interface 608. Energy rack interface 608 is configured to communicate with each of energy racks 104 that are components of energy rack system 312-1 and 312-2. Consequently, processor 602 receives operational data, as described below, from each of energy racks 104. Such data can be used to monitor and control the operation of each of energy rack systems 312-1 and 312-2. Further, the data can be used to detect operational faults that may occur during activation.

Processor 602 can further be coupled to a user interface 612. User interface 612 can include remote connections such as a cell or WiFi connections that allow a user to receive reports from control system 304 as well as allowing the user to provide instructions to control system 304.

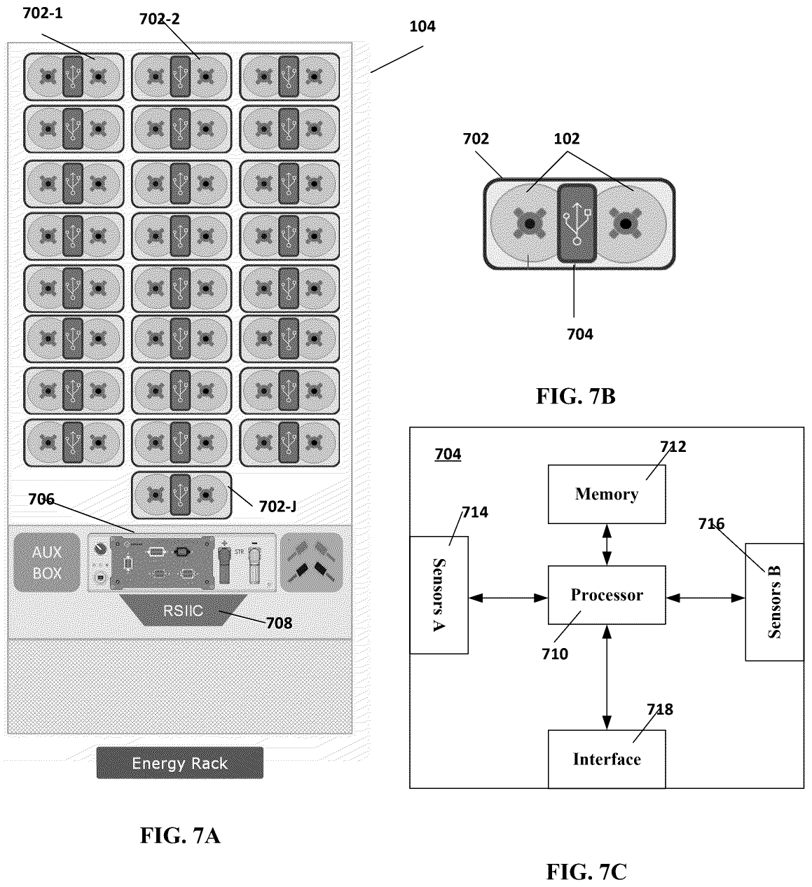

FIGS. 7A, 7B, and 7C illustrate a further example of energy rack 104 as was described in FIGS. 1A and 1B. As is illustrated in FIGS. 1A and 1B, energy rack 104 includes N batteries 102 (102-1 through 102-N) that are electrically coupled together, for example in series. In the example illustrated in FIGS. 7A and 7B, the N batteries 102-1 through 102-N are packaged in battery packs 702-1 through 702-J, where J=N/2. As illustrated in FIG. 7B, each pack 702 includes a monitor 704 that stores data related to the batteries 102 in battery pack 702 and can monitor various parameters of the batteries 102 in battery pack 702.

FIG. 7C illustrates an example of a monitor 704 according to some embodiments of the present disclosure. As illustrated, monitor 704 includes a memory 712 and a processor 710. Processor 710 can be any microcomputer, microprocessor, microcontroller, ASIIC, or other device capable of executing instructions for performing the tasks described here. Memory 712 can be any combination of volatile and non-volatile memory sufficient to hold data and instructions to be executed by processor 710 for performing the tasks described here. In some embodiments, memory 712 can be used to store specific data regarding each of batteries 102 in battery pack 702, for example activation data that is compiled during the activation process described here.

As is further illustrated, processor 710 is connected to a sensor group 714 that includes sensors that are coupled to one battery 102 of battery pack 702. Sensor group 714 includes the electronics for digitizing analog data received from individual sensors and presenting the digitized data to processor 710. In particular sensor group 714 can include sensors for measuring various parameters regarding one of batteries 102. Some of the parameters that may be monitored include pressure of the pressure vessel of battery 102, temperature, charge state, voltage, current, or other parameters. Processor 710 is further coupled to sensor group 716 that can be the same as sensor group 714 and is coupled to measure parameters of the other one of batteries 102 in battery pack 702.

As is further illustrated, processor 710 is connected to interface 718. Interface 718 provides digital connectivity to electronics 706 as illustrated in FIG. 7A. In particular, each monitor 704 of each of battery packs 702-1 through 702-J is coupled through its interface 718 to control module 706 of energy rack 104. Control module 706 can write data to each of modules 704 and can receive data from each of monitors 704 that includes the monitor parameters for each of batteries 102 included in energy rack 104.

As is further illustrated in FIG. 7A, an interface 708 is included that provides digital connectivity to control system 304. Consequently, control system 304 can receive data regarding each of batteries 102 in each energy rack 104 that is included in either of energy rack systems 312-1 or 312-2. Consequently, control system 304 can monitor for faults as well as write activation data into individual battery packs 702 of energy rack systems 312-1 and 312-2. In particular, the activation data can include individual vessel efficiencies (coulombic efficiency, energy efficiency, charge & discharge energy (in watt hour), charge and discharge energy (in amp hour), mean charge and discharge voltage for each of the cycles during the activation sequence 414 or 416. Note that activation sequences 414 and 416 illustrated in FIGS. 4 and 5 show three cycles of charging and discharging, however, the number of charge/discharge cycles in each of activation sequences 414 and 416 can vary based on the type of batteries 102 used in each of energy rack systems 312-1 and 312-2.

Furthermore, based on the activation data stored in monitors 704 of each battery pack 702, each of batteries 102 of each of energy rack systems 312-1 and 312-2 can be classified into tiers. This data can, therefore, be used to identify individual batteries 102 that are weak or mismatched with others in the same energy rack 104 of energy rack systems 312-1 and 312-2.

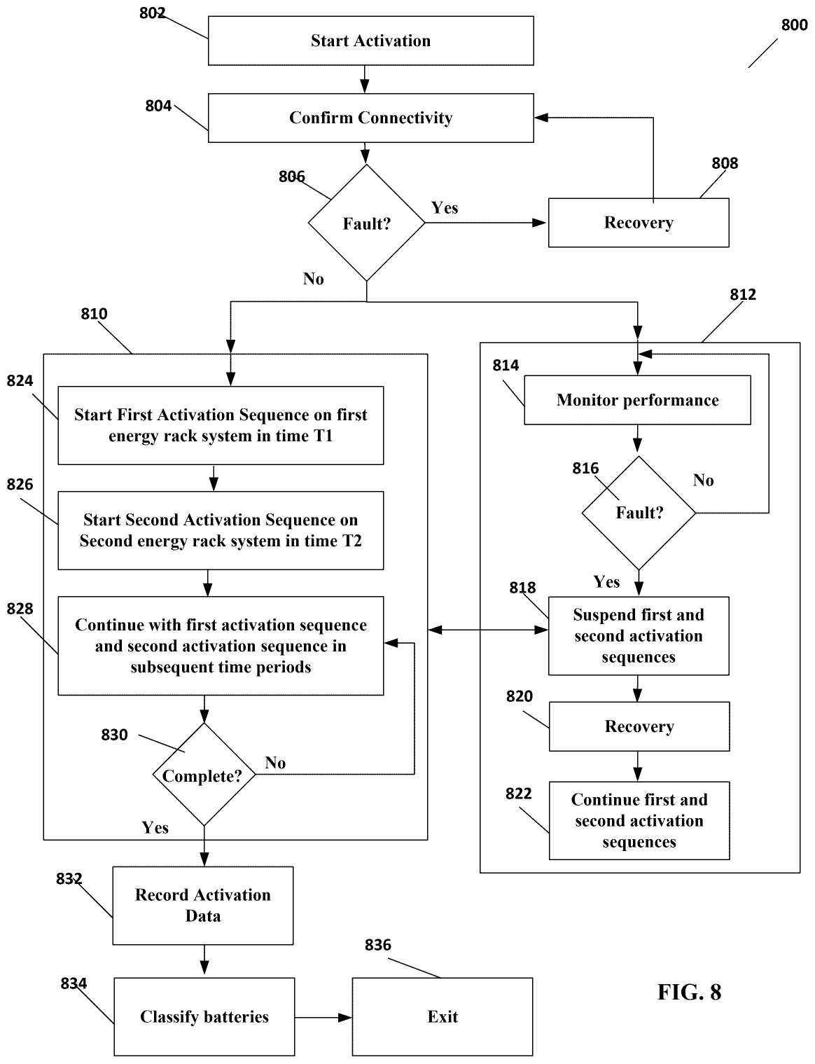

FIG. 8 illustrates an activation process 800 according to some embodiments of the present disclosure. Activation process 800 can be executed on control system 304 as illustrated in FIGS. 3 and 6 and instructions corresponding to activation process 800 stored in memory 604 as illustrated in FIG. 6. Activation process begins in start activation step 802. Start activation step 802 can be initiated by a technician after system 300 has been installed on a particular site. In step 804, control system 304 confirms that all connections are active, that all parameters of batteries 102 are within initial specifications, and power is available to inverters 302-1 and 302-2 from power grid 310. In step 806, if there are missing connections or other faults are detected, then process 800 proceeds to recovery 808. In recovery 808, whatever fault was detected in step 806 is rectified and process 800 returns to step 804. If there is no fault at step 806, then process 800 initiates two parallel process, activation sequencing process 810 and monitoring process 812. In process 810, activation process executes activation sequences 414 and 416 as is illustrated in FIGS. 4A and 4B. Throughout process 810, monitoring process 812 is executed that monitors the process, detects a fault if one occurs, and interrupts activation sequencing process 810 if a fault occurs to recover from the fault.

Activation sequencing step 810 starts in step 824, where a first activation sequence on a first energy rack system is started in time period T1. This step is shown in FIGS. 4A and 4B as charge cycle 402-1 of activation sequence 414 started on energy rack system 312-1 in time period T1. From step 824, activation sequencing step 810 proceeds to step 826, where a second activation sequence is started on a second energy rack system in time period T2. As discussed above, the first activation sequence is coordinated with the second activation sequence such that when one is charging the other is discharging. Step 824 is illustrated in FIGS. 4A and 4B, where activation sequence 416 is started on energy rack system 312-2 with charge cycle 410-1 during time period T2, while activation sequence 414 on energy rack system 312-1 has proceeded to discharge cycle 408-1. From step 824, activation sequencing step 810 proceeds to step 828 where the first activation sequence and the second activation sequence continues in subsequent time periods. The sequences continue through each time period until the entire sequence is finished. In step 830, activation sequencing step 810 determines whether each of sequences 414 and 416 are complete and, if not, activation sequence step 810 returns to step 828 until all time periods have been completed. If, in step 830, activation sequencing step 810 is complete, process 800 proceeds to step 832. In step 832, activation data is recorded into monitor 704 of each of battery packs 702 of each of energy rack systems 312-1 and 312-2. In step 834, each of batteries 102 in each energy rack 104 of each of energy rack systems 312-1 and 312-2 can be classified according to a tiering system and the results reported. Process 800 ends in step 836.

During the time that activation sequence process 810 is executing, monitoring process 812 is also executing. in step 814 control system 304 monitors performance of system 300. As discussed above, control system 304 can receive data from each of energy rack systems 312-1 and 312-2, data from inverters 302-1 and 302-2, and grid power from grid power meter 308. Monitoring process 812 then proceeds to step 816. If no fault is detected in step 816, then monitoring process 812 returns to step 814. However, if a fault is detected in step 816, then monitoring process 812 proceeds to step 818. In step 818, the activation sequence step 810 is suspended. In particular, the first and second activation sequencies that are operating in activation sequence step 810 is suspended and monitoring process 812 proceeds to recovery 820. In recovery 820, the fault detected in step 816 is rectified. In some cases, recovery 820 may involve intervention from technicians. Once recovery is complete in recovery step 820, monitoring process 812 proceeds to step 822 to restart the activation sequences and restarts activation sequence step 810 where it was interrupted.

The above detailed description is provided to illustrate specific embodiments of the present invention and is not intended to be limiting. Numerous variations and modifications within the scope of the present invention are possible. The present invention is set forth in the following claims.

What is claimed is:

1. A method of activating a battery system, comprising:
initiating a first activation sequence in a first time period on a first energy rack system, the first activation sequence including alternating charge and discharge cycles;
initiating a second activation sequence in a second time period following the first time period on a second energy rack system, the second activation sequence including alternating charge and discharge cycles; and
executing the first activation sequence and the second activation sequence until activation completion,
wherein the first activation sequence is coordinate with the second activation sequence such that charge cycles in the first activation sequence correspond with discharge cycles of the second activation sequence and discharge cycles in the first activation sequence correspond with charge cycles of the second activation sequence.

2. The method of claim 1, wherein each of the first energy rack system and the second energy rack system includes one or more coupled energy racks, each energy rack including a plurality of coupled batteries.

3. The method of claim 2, wherein the plurality of batteries in each energy rack are coupled in series.

4. The method of claim 2, wherein the plurality of coupled batteries in each energy rack are packaged in battery packs, each battery pack including a pair of batteries and a monitor coupled to the pair of batteries.

5. The method of claim 1, further including:
detecting a fault during execution of the first activation sequence and the second activation sequence;
suspending the first activation sequence and the second activation sequence;
recovering from the fault; and
resuming the first activation sequence and the second activation sequence.

6. The method of claim 5, wherein suspending the first activation sequence and the second activation sequence includes stopping the charge or discharge cycle of the first activation sequence and the corresponding discharge or charge cycle of the second activation sequence in a time period and resuming the charge or discharge cycle of the first activation sequence and the corresponding charge or discharge cycle of the second activation sequence to complete the time period.

7. The method of claim 4, further including recording activation data in each monitor of each battery pack.

8. The method of claim 7, further including classifying each of the batteries according to the activation data.

9. A battery system, comprising:
a first energy rack system;
a first inverter coupled to the first energy rack system, the first inverter configured to couple power between the first energy rack system and a power grid;
a second energy rack system;
a second inverter coupled to the second energy rack system, the second inverter configured to couple power between the second energy rack system and the power grid;
a power grid meter coupled to monitor power in the power grid; and
a control system coupled to the first energy rack system, the second energy rack system, the first inverter, the second inverter, and the power grid meter, the control system including a processor that executes instructions to activate the first energy rack system and the second energy rack system, the instructions include instructions to
initiate a first activation sequence in a first time period on a first energy rack system, the first activation sequence including alternating charge and discharge cycles;
initiate a second activation sequence in a second time period following the first time period on a second energy rack system, the second activation sequence including alternating charge and discharge cycles; and
execute the first activation sequence and the second activation sequence until activation completion,
wherein the first activation sequence is coordinate with the second activation sequence such that charge cycles in the first activation sequence correspond with discharge cycles of the second activation sequence and discharge cycles in the first activation sequence correspond with charge cycles of the second activation sequence.

10. The battery system of claim 9, wherein each of the first energy rack system and the second energy rack system includes one or more coupled energy racks, each energy rack including a plurality of coupled batteries.

11. The battery system of claim 10, wherein the plurality of batteries in each energy rack are coupled in series.

12. The battery system of claim 10, wherein the plurality of coupled batteries in each energy rack are packaged in battery packs, each battery pack including a pair of batteries and a monitor coupled to the pair of batteries.

13. The battery system of claim 9, wherein the instructions further include instructions to
detect a fault during execution of the first activation sequence and the second activation sequence;
suspend the first activation sequence and the second activation sequence;
recover from the fault; and
resume the first activation sequence and the second activation sequence.

14. The battery system of claim 13, wherein the instructions to suspend the first activation sequence and the second activation sequence includes instructions to stop the charge or discharge cycle of the first activation sequence and the corresponding discharge or charge cycle of the second activation sequence in a time period and instructions to resume the charge or discharge cycle of the first activation sequence and the corresponding charge or discharge cycle of the second activation sequence to complete the time period.

15. The battery system of claim 12, wherein the instructions further include instructions to record activation data in each monitor of each battery pack.

16. The battery system of claim 15, wherein the instructions further include instructions to classify each of the batteries from the activation data.
